(19) United States
(12) Patent Application Publication
(10) Pub. No.: US 2026/0120375 A1
(43) Pub. Date: Apr. 30, 2026

(54) MOTION-COMPENSATED RECONSTRUCTION IN AN IMAGING METHOD

(71) Applicant: Siemens Healthineers AG, Forchheim (DE)

(72) Inventors: Michael Manhart, Fürth (DE); Alexander Preuhs, Erlangen (DE)

(21) Appl. No.: 19/372,255

(22) Filed: Oct. 28, 2025

(30) Foreign Application Priority Data
Oct. 29, 2024 (DE) 10 2024 210 393.4

(51) Int. Cl. G06T 11/00

(52) U.S. Cl. CPC G06T 12/20; G06T 2211/412; G06T 2211/441

(57) ABSTRACT

For motion-compensated reconstruction in an imaging method, projection images generated by the imaging method that represent an object from a plurality of different projection directions are obtained. Three-dimensional first image data is reconstructed depending on the projection images. Consistency data that quantifies data consistency for each pair of projection images is generated. Input data is generated depending on the consistency data and the three-dimensional image data. Motion data characterizing a motion of the object and/or motion artifacts in the first image data is generated by applying a trained machine learning model to the input data. Three-dimensional at least partially motion-compensated second image data is reconstructed depending on the projection images and the motion data.

This application claims the benefit of German Patent Application No. DE 10 2024 210 393.4, filed on Oct. 29, 2024, which is hereby incorporated by reference in its entirety.

### BACKGROUND

The present embodiments relates to motion-compensated reconstruction in an imaging method, and training a machine learning model for use in motion-compensated reconstruction.

Patient motions pose a major challenge in medical imaging. This, for example, also affects imaging methods in which projection images with different projection directions are used to reconstruct three-dimensional image data, such as X-ray-based imaging methods (e.g., computed tomography (CT), cone beam computed tomography (CBCT) (e.g., cone beam CT), or tomosynthesis methods.

Motion-compensated reconstruction techniques may reduce motion artifacts by estimating or assuming a model of patient motion and taking this into account during reconstruction. To avoid poor-quality reconstructions and/or repeated recording, the reliability or accuracy of the model is crucial.

The publication by A. Preuhs et al.: “Appearance learning for image-based motion estimation in tomography,” IEEE Transactions on Medical Imaging, 39(11), 3667-3678 (2020), describes a deep autofocus (DAF) method for motion-compensated reconstruction in which a motion model is estimated by optimizing a learned image quality metric (IQM). The learned IQM is based on an artificial neural network (ANN) that is trained to predict a reproduction error (RPE) for slice images reconstructed from CBCT data. The RPE is then minimized during iterative reconstruction to compensate the motion.

An alternative approach is based on data consistency conditions (DCC) relating to the projection data as described in the publication by R. Frysch & G. Rose: “Rigid motion compensation in interventional C-arm CT using consistency measure on projection data,” Medical Image Computing and Computer-Assisted Intervention, MICCAI 2015: 18th International Conference, Munich, 2015, Proceedings, Part I 18, 298-306, Springer International Publishing. DCC-based motion compensation requires little computing power, but is limited to motions outside the capturing plane.

The publication by N. Hansen: “The CMA evolution strategy: A tutorial.” (arXiv:1604.00772) describes the CMA-ES optimization method.

The publication by Z. Liu et al.: “Swin transformer: Hierarchical vision transformer using shifted windows,” Proceedings of the IEEE/CVF international conference on computer vision, 10012-10022, describes a neural network referred to as Swin Transformer.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, accuracy of motion compensation during reconstruction in an imaging method is increased.

The present embodiments are based on the idea of using a trained machine learning model (MLM) to predict motion data characterizing a motion of the object to be mapped and/or corresponding motion artifacts. Herein, the MLM is applied to input data that depends on reconstructed three-dimensional image data and consistency data that quantifies data consistency for each pair of projection images underlying the reconstruction. A new reconstruction is then performed depending on the projection images and the predicted motion data.

According to one aspect of the present embodiments, a computer-implemented method is specified for motion-compensated reconstruction (e.g., at least partially motion-compensated reconstruction) in an imaging method (e.g., a medical imaging method). Herein, projection images generated by the imaging method that represent an object (e.g., an object to be mapped or an object that has been mapped) from a plurality of different projection directions are obtained. Three-dimensional first image data is reconstructed depending on the projection images. Consistency data, which quantifies data consistency for each pair of projection images, is generated (e.g., based on the projection images). Input data is generated depending on the consistency data and the first image data, and motion data is generated or predicted that characterizes a motion of the object (e.g., during the generation of the projection images or of raw data used to generate the projection images) and/or motion artifacts in the first image data. Herein, a trained machine learning model (MLM) is applied to the input data to generate the motion data. Three-dimensional at least partially motion-compensated, second image data is reconstructed depending on the projection images and the motion data.

Unless specified otherwise, all steps of the computer-implemented method are performed by a data processing system that includes at least one data processing device. For example, the at least one data processing device is configured or adapted to execute the acts of the computer-implemented method. For this purpose, the at least one data processing device may, for example, store a computer program that includes instructions that, when executed by the at least one data processing device, cause the at least one data processing device to execute the computer-implemented method. The computer-implemented method may also be entirely or partially implemented in hardware. Here and hereinafter, the terms “data processing system” and “at least one data processing device” may be used interchangeably. This also applies to corresponding terms derived therefrom.

In the event of the at least one data processing device including two or more data processing devices, certain acts performed by the at least one data processing device may also be that different data processing devices perform different acts or different parts of an act. For example, it is not necessary for each data processing device to perform the acts. In other words, the performance of the acts may be distributed among the two or more data processing devices.

In general terms, a trained MLM may mimic cognitive functions that humans associate with another human mind. For example, training based on training data enables the MLM to adapt to new circumstances and detect and extrapolate patterns. Another term for a trained MLM is “trained function.”

In general, the parameters of an MLM may be adapted or updated by training. Herein, for example, supervised training, semi-supervised training, unsupervised training, reinforcement learning, and/or active learning may be used. Further, representation learning (e.g., feature learning) may be used. For example, the parameters of MLMs may be adapted iteratively through a number of (e.g., several) training steps. For example, a specific loss function (e.g., a cost function) may be minimized during training. When training, an artificial neural network (ANN) (e.g., a backpropagation algorithm) may be used.

An MLM may, for example, include an ANN, a support vector machine, a decision tree, and/or a Bayesian network, and/or the MLM may be based on k-means clustering, Q-learning, genetic algorithms, and/or association rules. For example, an ANN may be or include a deep neural network, a convolutional neural network (CNN), or a convolutional deep neural network. Further, an ANN may be an adversarial network, a deep adversarial network, and/or a generative adversarial network (GAN).

In the computer-implemented method according to the present embodiments, the MLM generates output data by application to the input data, where the output data includes motion data or consists of the motion data.

For example, the projection images include a corresponding projection image for each projection direction of the plurality of different projection directions. For example, one projection image (e.g., exactly one projection image) is obtained for each projection direction of the plurality of different projection directions.

The projection images are, for example, generated based on raw data that is generated or captured or acquired by an imaging device. The generation of the raw data and the generation of the projection images are in each case not necessarily part of the computer-implemented method according to the present embodiments; the computer-implemented method according to the present embodiments may, for example, be downstream of the projection images. However, each embodiment of the computer-implemented method results in a corresponding embodiment of a method for motion-compensated reconstruction in an imaging method that is not purely computer-implemented by incorporating corresponding acts for generating the projection images.

The fact that the second image data is at least partially motion-compensated may, for example, be that the motion data is used to adapt the reconstruction for generating the second image data compared to the reconstruction for generating the first image data such that signatures or artifacts attributable to the motion of the object are completely or partially removed. For example, the strength of the motion artifacts in the second image data is lower than in the first image data.

The corresponding method acts may also be executed iteratively. In other words, further input data may be generated depending on the consistency data and the second image data, and further motion data may be generated by applying the MLM to the further input data. Then, three-dimensional third image data that, for example, has greater motion compensation than the second image data may be reconstructed depending on the projection images and the further motion data, and so on. In other words, the acts of the generation of the input data, the generation of the motion data, and the reconstruction may be iteratively repeated depending on the projection images and the motion data. The most recently reconstructed image data is in each case used to generate the input data for the following iteration. The iterations may also be performed as part of an optimization method.

The input data may include the consistency data and the first image data or consist of the consistency data and the first image data. Alternatively, it is possible that further processing or editing steps take place to process the consistency data and/or the first image data in order to generate the input data from the consistency data and the first image data.

In some embodiments, it is also possible for the consistency data and the first image data or the consistency data and processed image data dependent on the first image data to be merged (e.g., concatenated) in order to generate the input data.

The training of the MLM is likewise not necessarily part of the computer-implemented method for motion-compensated reconstruction according to the present embodiments. In other words, the MLM may be trained prior to the performance of the computer-implemented method according to the present embodiments. The MLM may, for example, be configured as an artificial neural network (ANN) (e.g., as a convolutional artificial neural network (CNN)) or as a transformer network, or may include one or more of the aforementioned networks. For example, the MLM may also be configured or created as described in the publication by Preuhs et al. or based thereon.

The first image data and the second image data may be reconstructed using a known image reconstruction method (e.g., a method in which the reconstruction is based on a motion model of the motion of the object), as explained, for example, in the publication by Preuhs et al.

For example, the motion model may be updated or adapted depending on the predicted or generated motion data in order to enable improved motion-compensated reconstruction. Alternatively or additionally, the motion data or parts of the motion data may be used as a measure for the motion artifacts or strength of the motion artifacts in an objective function for the iterative optimization of the reconstruction.

The object is, for example, an object to be mapped using the imaging method (e.g., a patient or a body part of the patient). Depending upon the embodiment of the imaging device or the imaging method, the projection images may be of different types. For example, an X-ray-based imaging method may be used (e.g., a CT method, a CBCT method, or a tomosynthesis method). In this case, the projection images are X-ray projection images.

Therefore, the reconstruction generates the three-dimensional reconstruction from the plurality of two-dimensional projection images in the form of the first image data or in the form of the second image data. Herein, the first image data or the second image data includes, for example, corresponding voxel values for a predetermined three-dimensional voxel grid for each voxel of the voxel grid, where the voxel values may, for example, correspond to attenuation values relating to the attenuation of X-rays or similar radiation used.

Since the projection images represent the same object according to a plurality of different projection directions, the pixel values of the projection images are generally not independent of one another. This may be quantified by corresponding data consistency for each pair of projection images in order to determine the consistency data. For example, the consistency conditions described in the document by Frysch and Rose mentioned in the introduction may be used.

In contrast to the DAF method mentioned in the introduction, the input data for the MLM for the computer-implemented method according to the present embodiments depends not only on the reconstructed data, but also on the consistency data. The data consistency of a pair of the projection images is disturbed or modified by a motion of the object during the generation of the projection images, at least for some pairs or a portion of the pairs. Therefore, the consistency data includes a characteristic signature of the motion of the object. Hence, by feeding the consistency data or information dependent thereon in each case to the MLM in addition to the first image data in order to predict the motion data, a more exact prediction of the motion data is achieved, and accordingly, improved accuracy in motion compensation and/or faster convergence of the optimization or iterative reconstruction, if used, is achieved.

According to at least one embodiment, the first image data is reconstructed depending on the projection images based on a predetermined initial motion model for the motion of the object. An adapted motion model is generated depending on the motion data and the initial motion model. The second image data is reconstructed depending on the projection images based on the adapted motion model.

The motion model may, for example, correspond to a description of a trajectory of the motion of the object or an approximate description of the trajectory or may include such a description or other parameters or characteristics of the motion of the object.

The generation of the first image data may, for example, correspond to an initial iteration of an iterative reconstruction method or optimization method for motion-compensated reconstruction. Depending on the first image data, it is then, for example, possible to calculate an objective function for the optimization and adapt the initial motion model depending on the objective function. For example, the objective function may depend on the motion data. The generation of the second image data then corresponds to an iteration following the first iteration. Further iterations may be performed analogously (e.g., until the value of the objective function lies within a predetermined target range).

According to at least one embodiment, the motion data includes a reproduction error or at least one other value that quantifies a strength of the motion artifacts in the first image data.

The reproduction error may, for example, be defined as described in the document by Preuhs et al. mentioned in the introduction. In addition to the first image data itself, the exact calculation of the reproduction error would also require reference image data that was generated without any motion of the object, or it would require an exact description of the motion of the object during the generation of the projection images. Since this is naturally not the case in the present constellation, in the aforementioned embodiments, the reproduction error is therefore predicted by the trained MLM or the at least one value that quantifies the strength of the motion artifacts in the first image data.

The reproduction error or the at least one value that quantifies the strength of the motion artifacts represents a measure of how strongly the motion of the object influences the first image data (e.g., in comparison to a hypothetical scenario in which no such motion would have taken place). Accordingly, the reproduction error or the at least one value that quantifies the strength of the motion artifacts may also be regarded as a measure of how successfully the motion compensation was realized during the reconstruction of the first image data. In an iterative reconstruction process, the reproduction error or the at least one value that quantifies the strength of the motion artifacts may, for example, be used as an error to be minimized within the framework of a corresponding objective function of the optimization.

Alternatively to or in addition to the reproduction error, the at least one value that quantifies the strength of the motion artifacts in the first image data may, for example, include a metric determined voxel-by-voxel.

The objective function of the optimization may, for example, depend on or correspond to the reproduction error or the at least one value that quantifies the strength of the motion artifacts.

According to at least one embodiment, the motion data includes a direction of motion of a translational motion of the object (e.g., during the generation of the projection images) and/or a rotational direction of a rotational motion of the object (e.g., during the generation of the projection images).

Therefore, the motion of the object, for example, includes a translational motion and/or a rotational motion.

The direction of motion of the translational motion may, for example, be provided as a direction vector in a three-dimensional coordinate system. The direction of motion may also be specified such that, for each of three coordinate axes of a Cartesian coordinate system, it is specified whether or not a motion or a significant motion has taken place along the corresponding coordinate axis. This may, for example, be specified in the form of a binary vector.

The rotational direction may, for example, likewise be provided by a direction vector that is parallel to an axis of rotation of the rotational motion and whose alignment specifies a direction of rotation about the axis of rotation. It is once again possible for the rotational direction to be specified such that, for each of the three coordinate axes, it is specified whether rotation about the corresponding coordinate axis is provided as the axis of rotation and, if so, in which direction.

The direction of motion of the translational motion and/or the rotational direction of the rotational motion may, for example, be taken into account in the reconstruction of the second image data for motion compensation. For example, in the optimization underlying the reconstruction, the solution space may be restricted such that only solutions corresponding to the direction of motion of the translational motion and/or the rotational direction of the rotational motion are considered or that such solutions are given preference.

For example, the direction of motion and/or the rotational direction may be used to generate the adapted motion model depending on the initial motion model. The adapted motion model may, for example, be adapted such that the adapted motion model includes a translational motion according to the direction of motion of the object and/or a rotational motion according to the rotational direction of the object as predicted by the MLM.

Such embodiments may, for example, achieve more effective motion compensation and/or faster convergence of the motion compensation (e.g., motion compensation in fewer iterations).

According to at least one embodiment, the motion data includes a motion trajectory of the motion of the object.

The motion trajectory may, for example, be provided as a time series of a position and/or orientation of the object in three-dimensional space (e.g., as a time series of a six-dimensional vector that, for each point in time, includes three values that define the position and three values that define the orientation, such as in the form of Euler angles or the like).

The motion trajectory may, for example, be taken into account in the reconstruction of the second image data for motion compensation. For example, in the optimization underlying the reconstruction, the solution space may be restricted such that only solutions corresponding to the motion trajectory are developed or that preference is given to such solutions.

For example, the motion trajectory may be used to generate the adapted motion model depending on the initial motion model. The adapted motion model may, for example, be adapted such that the adapted motion model includes a motion trajectory as predicted by the MLM.

Such embodiments may, for example, achieve more effective motion compensation and/or faster convergence of the motion compensation (e.g., motion compensation in fewer iterations).

According to at least one embodiment, the adapted motion model is generated as part of an optimization method in which the reproduction error or the at least one value that quantifies the strength of the motion artifacts in the first image data is optimized (e.g., minimized).

According to at least one embodiment, the adapted motion model is generated depending on the direction of motion and/or the rotational direction.

According to at least one embodiment, the adapted motion model is generated depending on the motion trajectory.

According to at least one embodiment, the consistency data includes an error matrix, where each entry in the error matrix is assigned to a pair of projection images and quantifies an inconsistency between the projection images of the respective pair corresponding to the motion artifacts.

For example, each row of the error matrix corresponds to one of the projection images, and each column of the error matrix corresponds to one of the projection images. Each entry defined by a row and a column of the error matrix then corresponds to the corresponding pair of projection images.

If, for example, there is no motion of the object during the generation of the projection images, the inconsistency between different projection images or projection images of different projection directions is, for example, always zero. Therefore, the value of the inconsistency reflects the influence of the motion on the data consistency between the projection images of the respective pair.

One advantage of using the error matrix as part of the input data or as the basis for the input data is that the error matrix may be processed substantially analogously to the image data or images derived therefrom.

The error matrix may, for example, be determined as described in the publication by Frysch et al., as mentioned in the introduction. In other words, the error matrix may be provided by

$${ε}_{ij} = \frac{1}{N} {\sum }_{n = 1}^{N} {\vert {S}_{i} ( {ϑ}_{i}^{n} , {s}_{i}^{n} ) - {S}_{j} ( {ϑ}_{j}^{n} , {s}_{j}^{n} ) \vert}^{p} ,$$

as defined in section 2.1 of the publication by Frysch et al.

According to at least one embodiment, a plurality of slice images is generated based on the three-dimensional image data, and the input data includes the plurality of slice images.

Herein, a slice image is, for example, a two-dimensional image extracted from the three-dimensional reconstruction of the first image data. For example, a slice image corresponds to a two-dimensional section through the three-dimensional reconstruction of the first image data.

According to at least one embodiment, the imaging method is a computed tomography (CT) method or a cone beam computed tomography (CBCT) method, or a tomosynthesis method.

In the case of a CT method or CBCT method, the first image data may, for example, be generated by full-angle reconstruction. In other words, the angle range covered by the different projection directions is large enough to enable a complete three-dimensional reconstruction. For example, the angle range is at least equal to 180° plus the fan angle of the X-ray beam used. For example, this may result in an angle range of at least 220°.

In alternative embodiments, the three-dimensional first image data includes at least two partial angle reconstructions (e.g., at least two different partial angle reconstructions), and the input data includes the at least two partial angle reconstructions.

For example, not all projection directions that would be necessary to generate a complete three-dimensional reconstruction are used to generate a partial angle reconstruction. In the above example, the angle range per partial angle reconstruction would be less than 220° or less than 180° (e.g., in the range of 10° to 120°).

For example, the two or more partial angle reconstructions together cover an angle range that would be required for a full-angle reconstruction (e.g., at least 180° plus the fan angle or at least 220°).

Providing two or more partial angle reconstructions makes different sources of information available to the MLM in which the effect of the motions of the object may be different in their degree or nature. The correspondingly trained MLM is therefore able to predict the motion data more accurately.

According to a further aspect of the present embodiments, a computer-implemented training method for training an MLM for use in a computer-implemented method (e.g., in a computer-implemented method according to the present embodiments) for motion-compensated reconstruction in an imaging method is specified. Herein, simulation of the imaging method while assuming a predetermined motion of an object to be mapped causes projection images to be simulated that represent the object from a plurality of different projection directions. Three-dimensional training image data is reconstructed depending on the simulated projection images. Annotation data for motion data characterizing the motion of the object and/or motion artifacts in the training image data is generated depending on the predetermined motion. Consistency training data quantifying data consistency for each pair of simulated projection images is generated. Training input data is generated depending on the consistency training data and the training image data. The motion data is predicted by applying the MLM (e.g., in an untrained or partially trained state) to the training input data. A value of a predetermined loss function is determined depending on the predicted data and the annotation data. The MLM is updated depending on the value of the loss function.

Herein, the aforementioned acts may be understood as an iteration of the training. The acts may be repeated with different objects and/or different motions of the object in a plurality of iterations. The iterations may, for example, be performed until a predefined termination or convergence criterion is met (e.g., until the value of the loss function lies within a corresponding predefined target range).

The predetermined motion may, for example, be determined by a corresponding motion trajectory. The annotation data corresponds structurally, for example, to the predicted motion data. For example, the motion data may include a reproduction error of the training image data and/or a direction of motion of a translational motion of the object and/or a rotational direction of a rotational motion of the object and/or the motion trajectory of the object, as described above with regard to the computer-implemented method according to the present embodiments for motion-compensated reconstruction. Consequently, the annotation data includes corresponding ground truth data for the reproduction error and/or the direction of motion of the translational motion and/or the rotational direction of the rotational motion and/or the motion trajectory. Since the projection images are generated by simulation, the associated annotation data is obtained with particularly little effort.

Further embodiments of the computer-implemented training method according to the present embodiments follow directly from the different embodiments of the computer-implemented method according to the present embodiments for motion-compensated reconstruction and vice versa. For example, individual features and corresponding explanations and advantages relating to the different embodiments of the computer-implemented method according to the present embodiments for motion-compensated reconstruction may be transferred analogously to corresponding embodiments of the computer-implemented training method according to the present embodiments.

According to at least one embodiment of the computer-implemented method according to the present embodiments for motion-compensated reconstruction, the MLM is or was trained using a computer-implemented training method according to the present embodiments.

According to a further aspect of the present embodiments, a data processing system is specified that is configured to perform a computer-implemented method according to the present embodiments for motion-compensated reconstruction and/or a computer-implemented training method.

In the present disclosure, the terms “data processing system” and “at least one data processing device” may be used interchangeably. A data processing device may, for example, be understood to be a data processing device containing a processing circuit. Therefore, the data processing device may, for example, process data for performing computing operations. This may also include operations for performing indexed access to a data structure (e.g., a look-up table (LUT)) or a data processing process implemented in hardware.

The data processing device may, for example, contain one or more computers, one or more microcontrollers, and/or one or more integrated circuits (e.g., one or more application-specific integrated circuits (ASICs), one or more field programmable gate arrays (FPGAs), and/or one or more systems on a chip (SoC)). The data processing device may also contain one or more processors (e.g., one or more microprocessors), one or more central processing units (CPUs), one or more graphics processing units (GPUs), and/or one or more signal processors (e.g., one or more digital signal processors (DSPs)). The data processing device may also include a physical or virtual cluster of computers or of the other units mentioned above.

In different example embodiments, the data processing device includes one or more hardware and/or software interfaces and/or one or more memory units.

A memory unit may be configured as a volatile data memory (e.g., a dynamic random access memory (DRAM) or static random access memory (SRAM)) or as a nonvolatile data memory (e.g., as a read-only memory (ROM), as a programmable read-only memory (PROM), as an erasable programmable read-only memory (EPROM), as an electrically erasable programmable read-only memory (EEPROM), as a flash memory or flash EEPROM, as a ferroelectric random access memory (FRAM), as a magnetoresistive random access memory (MRAM), or as a phase-change random access memory (PCRAM)).

According to a further aspect of the present embodiments, an imaging arrangement is specified with a data processing system configured to perform a computer-implemented method according to the present embodiments for motion-compensated reconstruction, as well as an imaging device configured to generate the projection images.

The imaging device may, for example, be an X-ray-based imaging device (e.g., a CT device or a CBCT device or a tomosynthesis device or a C-arm X-ray angiography device). The CBCT device or tomosynthesis device may also be configured as a C-arm device.

According to a further aspect of the present embodiments, a first computer program is specified with first instructions. When the first instructions are executed by a data processing system, the first instructions cause the data processing system to perform a computer-implemented method according to the present embodiments for motion-compensated reconstruction in an imaging method.

The first instructions may, for example, be in the form of program code. The program code may, for example, be provided as binary code or assembler and/or as source code of a programming language (e.g., C) and/or as a program script (e.g., Python).

According to a further aspect of the present embodiments, a second computer program is specified with second instructions. When the second instructions are executed by a data processing system, the second instructions cause the data processing system to perform the computer-implemented training method according to the present embodiments.

The second instructions may, for example, be in the form of program code. The program code may, for example, be provided as binary code or assembler and/or as source code of a programming language (e.g., C) and/or as a program script (e.g., Python).

According to a further aspect of the present embodiments, a computer-readable storage medium is specified (e.g., a physical and/or nonvolatile computer-readable storage medium) that stores a first computer program according to the present embodiments and/or a second computer program according to the present embodiments.

The first computer program, the second computer program, and the computer-readable storage medium are in each case computer program products with the first instructions or the second instructions.

Above and hereinafter, the solution according to the present embodiments is described both in relation to the claimed systems and in relation to the claimed methods. Features, advantages, or alternative embodiments may be assigned to the other claimed subject matter and vice versa. In other words, the claims and embodiments for the systems may be improved by features described or claimed in connection with the respective methods. In this case, the functional features of the method are implemented by physical units of the system.

Further, above and hereinafter, the solution according to the present embodiments is described in relation to methods and systems for motion-compensated reconstruction in an imaging method and in relation to methods and systems for providing a trained MLM. Features, advantages, or alternative embodiments may be assigned to the other claimed subject matter and vice versa. In other words, claims and embodiments for providing a trained MLM may be improved with features described or claimed in connection with motion-compensated reconstruction in an imaging method. For example, the datasets used in the method and systems may have the same properties and features as the corresponding datasets used in the methods and systems for providing a trained MLM, and the trained MLMs provided by the respective methods and systems may be used in the methods and systems for motion-compensated reconstruction in an imaging method.

Further features and combinations of features of the invention emerge from the figures and their description and from the claims. In particular, further embodiments of the invention do not necessarily have to contain all the features of one of the claims. Further embodiments of the inventions may have features or combinations of features that are not mentioned in the claims.

The invention is described in more detail below with reference to specific example embodiments and associated schematic drawings. In the figures, same or functionally same elements may be provided with the same reference symbols. The description of same or functionally same elements is not necessarily repeated with reference to different figures.

### BRIEF DESCRIPTION OF THE DRAWINGS

FIG. 1 is a schematic representation of an example embodiment of an imaging arrangement;

FIG. 2 is a schematic block diagram of an example embodiment of a computer-implemented method for motion-compensated reconstruction in an imaging method;

FIG. 3 is a schematic representation of an artificial neural network; and

FIG. 4 is a schematic representation of a convolutional neural network.

### DETAILED DESCRIPTION

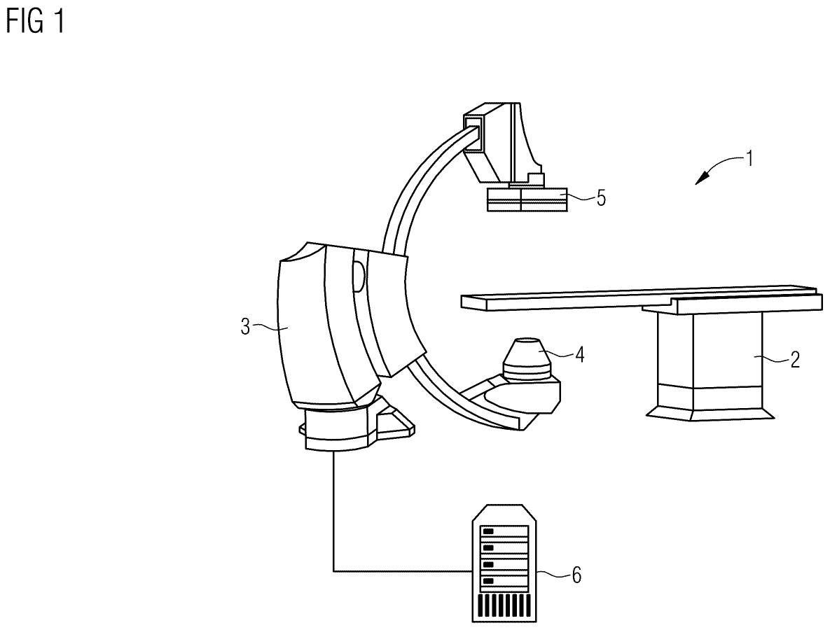

FIG. 1 is a schematic view of an example embodiment of an imaging arrangement 1. The imaging arrangement 1 has an imaging device 3 configured to generate a plurality of projection images 7 representing an object from a plurality of different projection directions.

The imaging device 3 is shown by way of example as a C-arm X-ray device with an X-ray source 4 and an X-ray detector 5. The imaging device 3 may therefore, for example, be embodied as a CBCT device. However, the following explanations may be transferred analogously to other imaging devices 3 that may generate projection images 7 representing an object from a plurality of different projection directions.

The object may, for example, be a patient or a body part of the patient. The patient may be placed on a patient bench 2 of the imaging arrangement 1.

The imaging arrangement 1 has a data processing system 6 according to the present embodiments configured to perform a computer-implemented method according to the present embodiments for motion-compensated reconstruction in an imaging method based on the projection images 7.

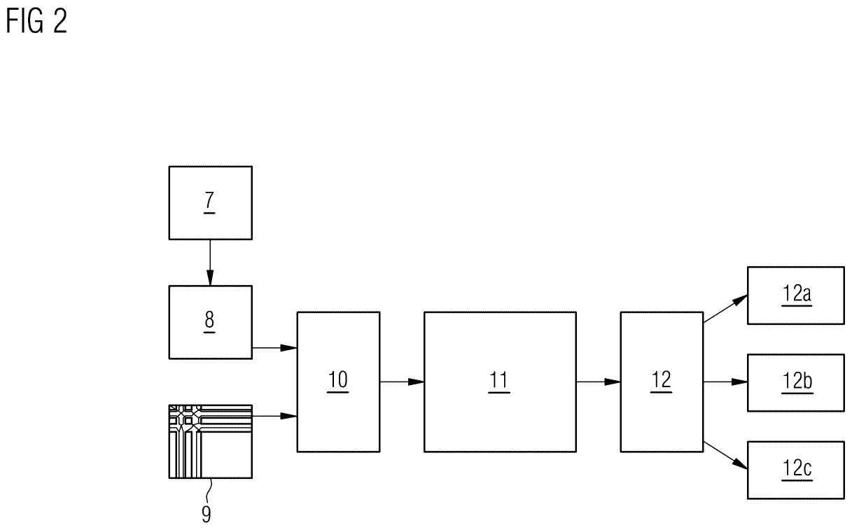

FIG. 2 shows a schematic block diagram of an example embodiment of such a computer-implemented method according to the present embodiments.

Herein, the projection images 7 are obtained, and three-dimensional first image data 8 is reconstructed depending on the projection images 7. Consistency data 9, which quantifies data consistency for each pair of projection images 7, is generated, and input data 10 is generated depending on the consistency data 9 and the first image data 8.

For example, the input data 10 may include the consistency data 9 and a plurality of slice images of the object extracted from the first image data 8. The consistency data 9 corresponds, for example, to an error matrix, where each entry in the error matrix is assigned to a pair of projection images 7 and quantifies an inconsistency between the projection images 7 of the respective pair corresponding to the motion artifacts. For example, the error matrix may correspond to the error matrix εᵢⱼ from the aforementioned publication by Frysch et al.

Motion data 12 characterizing a motion of the object and/or motion artifacts in the first image data 8 is generated by applying a trained MLM 11 to the input data 10. Three-dimensional at least partially motion-compensated second image data 8 is reconstructed depending on the projection images 7 and the motion data 12.

For example, the first image data 8 and the second image data may be generated as part of an iterative reconstruction method. Herein, for example, a measure for the motion-induced error susceptibility of the reconstructed image data in each case is minimized. For example, the reproduction error may be used as such a measure, as described in the publication by Preuhs et al. mentioned in the introduction. Possible optimization methods include simplex methods or methods based on the Monte Carlo method, such as, for example, covariance matrix adaption evolution strategy (CMA-ES).

For example, the first image data 8 may be reconstructed depending on the projection images 7 based on a predetermined initial motion model (e.g., in the form of a motion trajectory) for the motion of the object. The initial motion model may also correspond to a scenario in which the object is not subject to any motion.

An adapted motion model is then generated depending on the motion data 12 and the initial motion model, and the second image data is reconstructed depending on the projection images 7 based on the adapted motion model. In the next iteration, the input data 10 is generated based on the consistency data 9 and the second image data, and the MLM 11 is applied thereto in order to generate further motion data 12, and so on.

For example, the motion data 12 includes the reproduction error 12a. Based on the reproduction error 12a predicted or estimated by the MLM 11, the objective function of the optimization may then be evaluated and the motion model adapted correspondingly so that the reproduction error 12a is minimized.

For example, the motion data may include a motion classification 12b and/or a motion trajectory 12c for the motion of the object. The motion model may then be adapted directly corresponding to the motion classification 12b and/or the motion trajectory 12c.

The MLM 11 may, for example, be configured as an ANN (e.g., as an ANN with a feature extraction stage and a regression stage), as described in the aforementioned publication by Preuhs et al. However, the ANN may also have a different architecture (e.g., an architecture based on CNN or Transformer), such as, for example, the aforementioned Swin Transformer.

According to the present embodiments, the MLM 11 is applied to the input data 10, which is based not only on the first image data 8 (e.g., the slice images), but also on the consistency data 9 (e.g., the error matrix).

Different motion patterns are represented differently in the error matrix. Therefore, the shape and pattern of the inconsistencies in the error matrix provide a wealth of information that the MLM 11 may use in corresponding embodiments to estimate the motion data 12. For example, a translation peak of 1 mm along the cranial/caudal axis of the patient results in a different pattern than the same motion peak as rotation about this axis.

In combination with the first image data 8, there are therefore sufficient features available to predict the motion trajectory in some embodiments.

In some embodiments, the output of the MLM 11 is configured according to a multiclass learning approach. A first output of the MLM 11 is, for example, a scalar that encodes the total motion error (e.g., the reproduction error 12a).

In some embodiments, a second output of the MLM 11 is six-parameter coding in which the respective motion axis is specified as a vector (e.g., tx, ty, tz, rx, ry, rz) of the motion classification 12b in which the motion takes place. Herein, tx, ty, tz correspond to translational motions in the x-, y- or z-directions, whereas rx, ry, rz correspond to rotational motions about the x-, y- or z-directions. The inputs of the vector may, for example, be 0 or 1, depending on whether or not a corresponding motion is predicted. If necessary, a +/− sign may indicate the direction of the respective motion component.

In some embodiments, a third output of the MLM 11 is a direct prediction of the motion trajectory 12c. The motion trajectory 12c may, for example, be encoded as a fixed spline. However, it is also possible for the MLM 11 to define the number and distribution of the simplex nodes defined, or, in general terms, the structure of the motion, such as high-frequency motion or low-frequency motion in the middle part of the motion trajectory 12c, and so on.

The MLM 11 may, for example, be trained by using motionless scans or simulated scans and synthetically adding the motion. This enables the provision of a reference standard for the respective outputs and subsequent training of the MLM 11.

After training, the MLM 11 may, for example, be used for optimization. Alternatively or additionally, the motion classification 12b and/or the motion trajectory 12c may be used to restrict the solution space of the optimization.

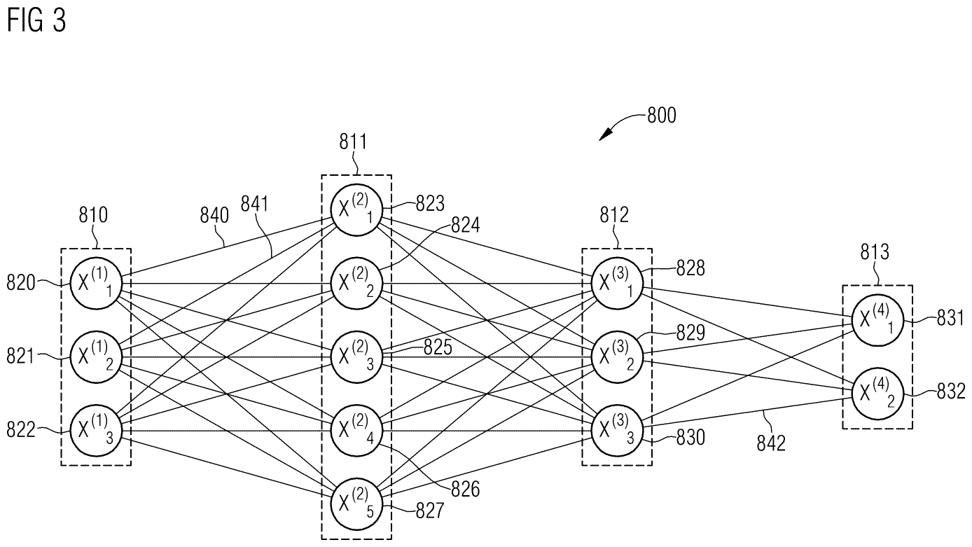

FIG. 3 shows an embodiment of an artificial neural network (ANN) 800. The ANN 800 includes nodes 820, . . . , 832 and edges 840, . . . , 842, where each edge 840, . . . , 842 is a directional connection from a first node 820, . . . , 832 to a second node 820, . . . , 832. In general, the first node 820, . . . , 832 and the second node 820, . . . , 832 are different nodes 820, . . . , 832. It is, however, also possible for the first node 820, . . . , 832 and the second node 820, . . . , 832 to be the same. In the example in FIG. 3, the edge 840 is a directional connection from node 820 to node 823, and the edge 842 is a directional connection from node 830 to node 832. An edge 840, . . . , 842 from a first node 820, . . . , 832 to a second node 820, . . . , 832 is also designated an incoming edge for the second node 820, . . . , 832 and an outgoing edge for the first node 820, . . . , 832.

In this example, nodes 820, . . . , 832 of the ANN 800 may be arranged in layers 810, . . . , 813, where the layers may have an intrinsic order that is introduced by edges 840, . . . , 842 between nodes 820, . . . , 832. For example, edges 840, . . . , 842 may only be present between adjacent layers of nodes. In the example shown, there is an input layer 810 consisting only of nodes 820, . . . , 822 without incoming edges, an output layer 813 consisting only of nodes 831, 832 without outgoing edges, and hidden layers 811, 812 between input layer 810 and output layer 813. In general, the number of hidden layers 811, 812 may be selected at will. In a multilayer perceptron (MLP), this number is at least one. The number of nodes 820, . . . , 822 within input layer 810 may refer to the number of input values of artificial neural network 800, and the number of nodes 831, 832 within output layer 813 may refer to the number of output values of artificial neural network 800.

For example, each node 820, . . . , 832 of artificial neural network 800 may be allocated a real number as a value. Herein, x⁽ⁿ⁾ᵢ designates the value of the i-th node 820, . . . , 832 of the n-th layer 810, . . . , 813. The values of nodes 820, . . . , 822 of input layer 810 correspond to the input values of artificial neural network 800. The values of nodes 831, 832 in output layer 813 correspond to the output value of artificial neural network 800. Further, each edge 840, . . . , 842 may have a weight that is a real number. For example, the weight is a real number within the range [−1, 1] or within the range [0, 1]. Herein, w^{(m,n)}_{i,j} designates the weight of the edge between the i-th node 820, . . . , 832 of the m-th layer 810, . . . , 813 and the j-th node 820, . . . , 832 of the n-th layer 810, . . . , 813. Further, the abbreviation w⁽ⁿ⁾_{i,j} is defined for the weight w^{(n,n+1)}_{i,j}. In order to calculate the output values of neural network 800, the input values are, for example, propagated through neural network 800. For example, the values of nodes 820, . . . , 832 of the (n+1)-th layer 810, . . . , 813 may be calculated based on the values of nodes 820, . . . , 832 of the n-th layer 810, . . . , 813 by

$${x}_{j}^{( n + 1 )} = f ( {\sum }_{i} {x}_{i}^{( n )} {w}_{i , j}^{( n )} ) .$$

Herein, the function f is designated the transfer function or activation function. Known transfer functions are step functions, sigmoid functions (e.g., the logistic function), the generalized logistic function, the hyperbolic tangent, the arctangent function, the error function, the smoothstep function, or rectifier functions. The transfer function is, for example, used for normalization. For example, the values are propagated layer-by-layer through neural network 800, where the values of input layer 810 are provided by the input of neural network 800, the values of the first hidden layer 811 may be calculated based on the values of input layer 810 of neural network 800, the values of the second hidden layer 812 may be calculated based on the values of the first hidden layer 811, and so on.

In order to define the values w^{(m,n)}_{i,j} for the edges, the neural network 800 is to be trained with training data. The training data, for example, includes training input data and training output data (e.g., designated tᵢ). In a training step, neural network 800 is applied to the training input data in order to generate calculated output data. For example, the training data and the calculated output data include a number of values corresponding to the number of nodes in the output layer. For example, a comparison between the calculated output data and the training data is used to recursively adapt the weights within neural network 800 (e.g., back propagation algorithm). For example, the weights are modified according to the following formula

$${w}_{i , j}^{′ ( n )} = {w}_{i , j}^{( n )} - γ {δ}_{j}^{( n )} {x}_{i}^{( n )} ,$$

where γ is a predefined learning rate, and the numbers δ⁽ⁿ⁾ⱼ may be recursively calculated by

$${δ}_{j}^{( n )} = ( {\sum }_{k} {δ}_{k}^{( n + 1 )} {w}_{j , k}^{( n + 1 )} ) {f}^{′} ( {x}_{i}^{( n )} {w}_{i , j}^{( n )} )$$

based on δ⁽ⁿ⁺¹⁾ⱼ, if the (n+1)-th layer is not the output layer 813, and

$${δ}_{j}^{( n )} = ( {x}_{j}^{( n + 1 )} - {t}_{j}^{( n + 1 )} ) {f}^{′} ( {x}_{i}^{( n )} {w}_{i , j}^{( n )} ) ,$$

if the (n+1)-th layer is the output layer 813, where f′ is the first derivative of the activation function and t⁽ⁿ⁺¹⁾ⱼ is the comparison training value for the j-th node in output layer 813.

A convolutional neural network (CNN) is an ANN that uses a convolution operation instead of a general matrix multiplication in at least one of its layers. These layers are designated convolutional layers. For example, a convolutional layer performs a dot product between one or more convolution kernels and the input data of the convolutional layer. The inputs of the one or more convolution kernels are parameters or weights that may be adapted by training. For example, the Frobenius inner product and the ReLU activation function may be used. A convolutional neural network may include additional layers (e.g., pooling layers, fully connected layers, and/or normalization layers).

The use of convolutional neural networks enables the input to be processed very efficiently, since a convolution operation based on different kernels may extract different image features so that the adaptation of the weights of the convolution kernel enables the relevant image features to be determined during training. Further, combined use of the weights in the convolution kernels provides that fewer parameters need to be trained, thus preventing overadaptation in the training phase and enabling faster training or more layers in the network. This improves network performance.

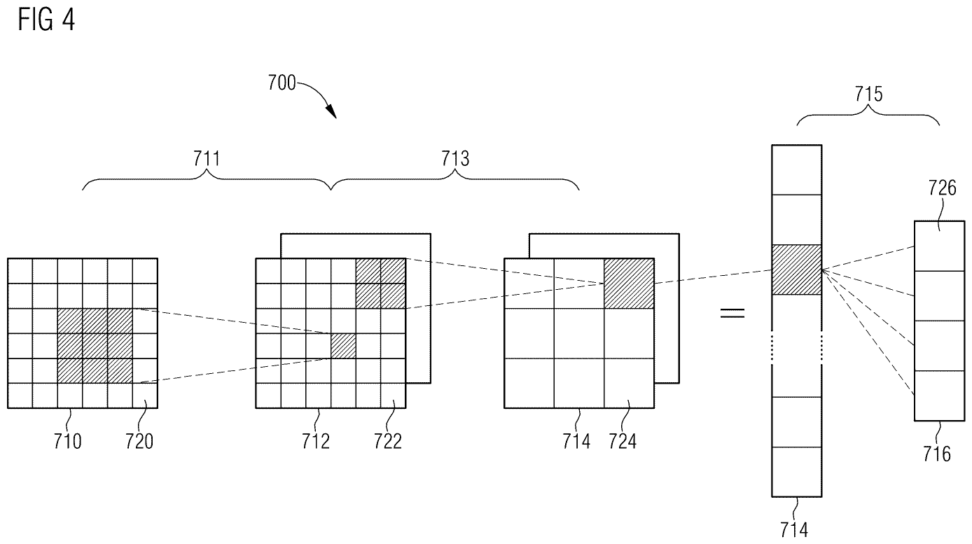

FIG. 4 shows an example embodiment of a convolutional neural network 700. In the embodiment depicted, the convolutional neural network 700 includes an input node layer 710, a convolutional layer 711, a pooling layer 713, a fully connected layer 714, and an output node layer 716 together with hidden node layers 712, 714. Alternatively, the convolutional neural network 700 may also include a plurality of convolutional layers 711, a plurality of pooling layers 713, and/or a plurality of fully connected layers 715 together with other types of layers. The order of the layers may be selected at will; fully connected layers 715 may be used as the final layers before the output layer 716.

For example, in a convolutional neural network 700, the nodes 720, 722, 724 in a node layer 710, 712, 714 may be regarded as a d-dimensional matrix or as a d-dimensional image. For example, in the two-dimensional case, the value of the node 720, 722, 724 indicated with i and j in the n-th node layer 710, 712, 714 may be designated x(n)[i, j]. However, the arrangement of nodes 720, 722, 724 in a node layer 710, 712, 714 has no influence as such on the calculations performed within the convolutional neural network 700, since these are determined solely by the structure and weights of the edges.

A convolutional layer 711 is a connecting layer between a front node layer 710 with node values x(n−1) and a rear node layer 712 with node values x(n). A convolutional layer 711 is, for example, characterized by the structure and weights of the incoming edges that form a convolution operation based on a certain number of kernels. For example, the structure and weights of the edges of the convolutional layer 711 are selected such that the values x(n) of the nodes 722 in the rear node layer 712 are calculated as a convolution x(n)=K*x(n−1) based on the values x(n−1) of the nodes 720 in the front node layer 710, where the convolution * in the two-dimensional case is defined by

$${x}^{( n )} [ i , j ] = ( K * {x}^{( n - 1 )} ) [ i , j ] = {\sum }_{i ′} {\sum }_{j ′} K [ {i}^{′} , {j}^{′} ] \cdot {x}^{( n - 1 )} [ i - {i}^{′} , j - {j}^{′} ] .$$

Herein, the kernel K is a d-dimensional matrix (e.g., in the present example, a two-dimensional matrix) that may be small compared to the number of nodes 720, 722 (e.g., a 3×3 matrix or a 5×5 matrix). This, for example, provides that the weights of the edges in the convolutional layer 711 are not independent but are selected such that the weights result in the aforementioned convolution equation. For example, for a kernel that is a 3×3 matrix, there are only 9 independent weights, where each entry in the kernel matrix corresponds to an independent weight, regardless of the number of nodes 720, 722 in the front node layer 710 and the rear node layer 712.

In general, convolutional neural networks 700 use node layers 710, 712, 714 with a plurality of channels (e.g., due to the use of a plurality of kernels in the convolutional layers 711) In these cases, the node layers may be regarded as (d+1)-dimensional matrices, where the first dimension indicates the channels. The effect of a convolutional layer 711 is then defined in a two-dimensional example by

$${x}_{b}^{( n )} [ i , j ] = {\sum }_{a} ( {K}_{a , b} * {x}_{a}^{( n - 1 )} [ i , j ] = {\sum }_{a} {\sum }_{i ′} {\sum }_{j ′} {K}_{a , b} [ {i}^{′} , {j}^{′} ] \cdot {x}_{a}^{( n - 1 )} [ i - {i}^{′} , j - {j}^{′} ] ,$$

where

$${x}_{a}^{( n )}$$

corresponds to the a-th channel of the preceding node layer 710,

$${x}_{b}^{( n )}$$

corresponds to the b-th channel of the subsequent node layer 712, and K_{a,b} corresponds to one of the kernels. If a convolutional layer 711 acts on a preceding node layer 710 with A-channels and outputs a subsequent node layer 712 with B-channels, there are A·B independent d-dimensional kernels K_{a,b}.

In general, activation functions may be used in convolutional neural networks 700. In this embodiment, rectified linear unit (ReLU) is used, with R(z)=max(0, z), so that the effect of the convolutional layer 711 in the two-dimensional example is

$${x}_{b}^{( n )} [ i , j ] = R \text{ } \text{} ( \text{} {\sum }_{a} ( {K}_{a , b} * {x}_{a}^{( n - 1 )} [ i , j ] ) = R ( {\sum }_{a} {\sum }_{{i}^{′}} {\sum }_{{j}^{′}} {K}_{a , b} [ {i}^{′} , {j}^{′} ] \cdot {x}_{a}^{( n - 1 )} [ i - {i}^{′} , j - {j}^{′} ] ) .$$

It is also possible to use other activation functions (e.g., exponential linear unit (ELU)), LeakyReLU, sigmoid, tanh, or softmax.

In the embodiment shown, the input layer 710 includes 36 nodes 720 arranged in a two-dimensional 6×6 matrix. The first hidden node layer 712 includes 72 nodes 722 arranged as two-dimensional 6×6 matrices, where each of the two matrices is the result of a convolution of the values of the input layer with a 3×3 kernel within the convolutional layer 711. Equivalently, the nodes 722 of the first hidden node layer 712 may be interpreted as a three-dimensional 2×6×6 matrix, where the first dimension corresponds to the channel dimension.

One advantage of the use of convolutional layers 711 is that a spatially local correlation of the input data may be utilized by enforcing a local connectivity pattern between the nodes in adjacent layers (e.g., by only connecting each node to a small region of the nodes in the preceding layer).

A pooling layer 713 is a connecting layer between a preceding node layer 712 with node values x(n−1) and a subsequent node layer 714 with node values x(n). A pooling layer 713 may, for example, be characterized by the structure and weights of the edges and the activation function that form a pooling operation based on a nonlinear pooling function f. For example, in the two-dimensional case, the values x(n) of the nodes 724 of the subsequent node layer 714 may be calculated based on the values x(n−1) of the nodes 722 of the anterior node layer 712 as follows

$${x}_{b}^{( n )} [ i , j ] = f ( {x}_{b}^{( n - 1 )} [ {id}_{1} , {jd}_{2} ] , … , {x}_{b}^{( n - 1 )} [ ( i + 1 ) {d}_{1} - 1 , ( j + 1 ) {d}_{2} - 1 ] ) .$$

In other words, the use of a pooling layer 713 enables the number of nodes 722, 724 to be reduced by replacing a number d1-d2 of adjacent nodes 722 in the preceding node layer 712 by one single node 722 in the subsequent node layer 714 that is calculated as a function of the values of the aforementioned number of adjacent nodes. The pooling function f may, for example, be the max function, the average or the L2 norm. For example, in a pooling layer 713, the weights of the incoming edges are fixed and not modified by training.

The advantage of using a pooling layer 713 is that the number of nodes 722, 724 and the number of parameters is reduced. This results in a reduction in computational effort in the network and control of overadaptation.

In the embodiment shown, the pooling layer 713 is a max pooling layer in which four adjacent nodes are replaced by only one node, where the value is the maximum of the values of the four adjacent nodes. Max pooling is applied to each d-dimensional matrix of the preceding layer. In this embodiment, max pooling is applied to each of the two-dimensional matrices, whereby the number of nodes is reduced from 72 to 18.

In general, the final layers of a convolutional neural network 700 may be fully connected layers 715. A fully connected layer 715 is a connecting layer between a preceding node layer 714 and a subsequent node layer 716. A fully connected layer 713 may be characterized in that a majority (e.g., all) of the edges between the nodes 714 in the preceding node layer 714 and the nodes 716 in the subsequent node layer are present. The weight of each of these edges may be adapted individually.

In this embodiment, the nodes 724 in the front node layer 714 of the fully connected layer 715 are represented both as two-dimensional matrices and additionally as non-contiguous nodes, shown as a line of nodes, where the number of nodes has been reduced for greater ease of depiction. This process is also known as flattening. In this embodiment, the number of nodes 726 in the subsequent node layer 716 of the fully connected layer 715 is less than the number of nodes 724 in the preceding node layer 714. Alternatively, the number of nodes 726 may also be equal or greater.

Further, in this embodiment, the softmax activation function is used within the fully connected layer 715. Applying the softmax function causes the sum of the values of all nodes 726 in the output layer 716 to be equal to 1, and all values of all nodes 726 in the output layer 716 to be real numbers between 0 and 1. For example, when using the convolutional neural network 700 to categorize input data, the values of the output layer 716 may be interpreted as the probability of the input data falling into one of the different categories.

For example, convolutional neural networks 700 may be trained based on a backpropagation algorithm. To prevent overadaptation, regularization methods may be used (e.g., omitting nodes 720, . . . , 724, stochastic pooling, the use of artificial data, weight reduction based on the L1 or L2 norm, or max norm constraints).

In the preceding description, independent of the grammatical term usage, individuals with male, female, or other gender identities are included within the term.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A computer-implemented method for motion-compensated reconstruction in an imaging method, the computer-implemented method comprising:
obtaining projection images generated by the imaging method that represent an object from a plurality of different projection directions;
reconstructing three-dimensional first image data depending on the projection images;
generating consistency data that quantifies data consistency for each pair of the projection images;
generating input data depending on the consistency data and the three-dimensional first image data;
generating motion data characterizing a motion of the object, generating motion artifacts in the three-dimensional first image data, or a combination thereof, the generating of the motion artifacts comprising applying a trained machine learning model to the input data; and
reconstructing three-dimensional at least partially motion-compensated second image data depending on the projection images and the motion data.

2. The computer-implemented method of claim 1, wherein the motion data includes a reproduction error or includes at least one value quantifying a strength of the motion artifacts in the first image data.

3. The computer-implemented method of claim 1, wherein the motion data includes a direction of motion of a translational motion of the object, a rotational direction of a rotational motion of the object, or the direction of motion and the rotational direction.

4. The computer-implemented method of claim 1, wherein the motion data includes a motion trajectory of the motion of the object.

5. The computer-implemented method of claim 2, wherein:
the first image data is reconstructed depending on the projection images based on a predetermined initial motion model for the motion of the object;
an adapted motion model is generated depending on the motion data and the initial motion model; and
the second image data is reconstructed depending on the projection images based on the adapted motion model.

6. The computer-implemented method of claim 5, wherein the adapted motion model is generated as part of an optimization method in which the reproduction error or the at least one value that quantifies the strength of the motion artifacts in the first image data is optimized.

7. The computer-implemented method of claim 5, wherein the motion data includes a direction of motion of a translational motion of the object, a rotational direction of a rotational motion of the object, or the direction of motion and the rotational direction, and
wherein the adapted motion model is generated depending on the direction of motion, the rotational direction, or the direction of motion and the rotational direction.

8. The computer-implemented method of claim 5, wherein the motion data includes a motion trajectory of the motion of the object, and
wherein the adapted motion model is generated depending on the motion trajectory.

9. The computer-implemented method of claim 1, wherein the consistency data includes an error matrix, and
wherein each entry in the error matrix is assigned to a pair of projection images and quantifies an inconsistency between the projection images of the respective pair corresponding to the motion artifacts.

10. The computer-implemented method of claim 1, further comprising generating a plurality of slice images based on the three-dimensional first image data,
wherein the input data includes the plurality of slice images.

11. The computer-implemented method of claim 1, wherein the imaging method is a computed tomography method or a cone beam computed tomography method.

12. The computer-implemented method of claim 11, wherein the three-dimensional first image data includes at least two partial angle reconstructions, and the input data includes the at least two partial angle reconstructions.

13. A computer-implemented training method for training a machine learning model (MLM) for use in a computer-implemented method for motion-compensated reconstruction in an imaging method, the computer-implemented method comprising:
simulating the imaging method while assuming a predetermined motion of an object to be mapped causes projection images to be simulated that represent the object from a plurality of different projection directions;
reconstructing three-dimensional training image data depending on the simulated projection images;
generating annotation data for motion data characterizing the motion of the object, motion artifacts, or a combination thereof in the training image data depending on the predetermined motion;
generating consistency training data quantifying data consistency for each pair of simulated projection images;
generating training input data depending on the consistency training data and the training image data;
predicting the motion data, the predicting of the motion data comprising applying the MLM to the training input data;
determining a value of a predetermined loss function depending on the predicted data and the annotation data; and
updating the MLM depending on the value of the predetermined loss function.

14. A data processing system comprising:
a processor configured for motion-compensated reconstruction in an imaging method, the processor being configured for motion-compensated reconstruction comprising the processor being configured to:
obtain projection images generated by the imaging method that represent an object from a plurality of different projection directions;
reconstruct three-dimensional first image data depending on the projection images;
generate consistency data that quantifies data consistency for each pair of the projection images;
generate input data depending on the consistency data and the three-dimensional first image data;
generate motion data characterizing a motion of the object, generate motion artifacts in the three-dimensional first image data, or a combination thereof, the generation of the motion artifacts comprising application of a trained machine learning model to the input data; and
reconstruct three-dimensional at least partially motion-compensated second image data depending on the projection images and the motion data.

15. A data processing system comprising:
a processor configured for training a machine learning model (MLM) for use in a computer-implemented method for motion-compensated reconstruction in an imaging method, the processor being configured for training the MLM comprising the processor being configured to:
simulate the imaging method while assuming a predetermined motion of an object to be mapped causes projection images to be simulated that represent the object from a plurality of different projection directions;
reconstruct three-dimensional training image data depending on the simulated projection images;
generate annotation data for motion data characterizing the motion of the object, motion artifacts, or a combination thereof in the training image data depending on the predetermined motion;
generate consistency training data quantifying data consistency for each pair of simulated projection images;
generate training input data depending on the consistency training data and the training image data;
predict the motion data, the prediction of the motion data comprising application of the MLM to the training input data;
determine a value of a predetermined loss function depending on the predicted data and the annotation data; and
update the MLM depending on the value of the predetermined loss function.
